(19) United States
(12) Patent Application Publication
(10) Pub. No.: US 2025/0295100 A1
(43) Pub. Date: Sep. 25, 2025

(54) VARIABLE RIGIDITY EQUINE SHOE

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 19/088,002

(22) Filed: Mar. 24, 2025

Related U.S. Application Data
(60) Provisional application No. 63/568,637, filed on Mar. 22, 2024.
(60) Provisional application No. 63/571,067, filed on Mar. 28, 2024.

(51) Int. Cl. A01L 5/00; A01L 1/02

(52) U.S. Cl. CPC A01L 5/00; A01L 1/02

(57) ABSTRACT

An equine foot support device including a metal clement and an overmolded polymer element.

### CROSS-REFERENCE TO RELATED APPLICATIONS

This application claims the priority benefit of U.S. Provisional Application No. 63/568,637, filed Mar. 22, 2024, and U.S. Provisional Application No. 63/571,067, filed Mar. 28, 2024, both of which are incorporated herein by reference in their entirety.

### FIELD OF THE INVENTION

This patent application relates to equine shoes.

### BACKGROUND

Traditional horseshoes are typically made of metal, such as steel or aluminum. Such shoes are secured to a horse's hoof with nails. Traditional horseshoes, however, suffer from a number of known drawbacks that hinder performance. These include excessive rigidity, lack of traction in adverse weather or riding conditions and undue weight. In an effort to address some of these drawbacks, certain modern equine shoes have a sole formed of urethane in lieu of traditional steel or aluminum. Similar to traditional horseshoes, such urethane-soled horseshoes are secured to a horse's hoof with nails.

While each of the many prior-art horseshoes defined by this general description provides advantages over traditional shoe designs, they all suffer from a number of persistent and performance-limiting drawbacks. While traditional, metal shoes are made of a durable material, they present persistent challenges in the manner in sizing and securing them to horses. Further, they restrict horse hooves from their natural range of motion.

Modern equine shoes, have a number of drawbacks of their own, including the less durable and less rigid/supportive nature of polymers relative to metals. Moreover, urethane, nail-on shoes have additional, significant drawbacks. One drawback is that the urethane permits rocks or other debris approximating the nail head size to drive the nails deeper and deeper into the urethane sole and horse hoof. Over time, this loosens the shoe clinch and ultimately leads to failure of the shoe. To improve durability, such shoes are sometimes provided with a steel core, but steel cores offer extremely limited flexion and can damage the urethane. Moreover, steel core shoes can pose some of the same issues as metal shoes. That is, steel core shoes can unduly hinder flexion of the hoof.

What is needed, therefore, is an equine shoe that improves upon or resolves one or more of these drawbacks.

### SUMMARY

This application discloses an equine shoe with a rigid distal zone generally corresponding with the coffin bone or the distal phalanx, and a less rigid proximal zone generally corresponding with the frog.

### BRIEF DESCRIPTION OF THE DRAWINGS

Embodiments of the application will be described in detail in conjunction with FIGS. 1-22.

FIG. 1 is a perspective side view of a shoe according to the disclosure.

FIG. 2 is a top view of the shoe of FIG. 1.

FIG. 3 is a perspective bottom view of the shoe of FIG. 1. FIG. 4 is a bottom view of the shoe of FIG. 1.

FIG. 5 is a perspective bottom view of the shoe of FIG. 1.

FIG. 6 is a top view of the shoe of FIG. 1.

FIG. 7 is a perspective bottom view of the shoe of FIG. 1.

FIG. 8 is a perspective side view of the shoe of FIG. 1.

FIG. 9 is a bottom view of a shoe according to the disclosure.

FIG. 10 is a cutaway side view of the shoe of FIG. 9 along line A.

FIG. 11 is a perspective side view cutaway of the shoe of FIG. 9 along line A.

FIG. 12 is a side view of the shoe of FIG. 9.

FIG. 13 is a perspective bottom view of the shoe of FIG. 9.

FIG. 14 is a perspective side view of the shoe of FIG. 9.

FIG. 15 is a bottom view of a shoe according to the disclosure.

FIG. 16 is a top view of a shoe according to the disclosure.

FIG. 17 is a top view of a shoe according to the disclosure.

FIG. 18 is a bottom view of a rigid element and wire according to the disclosure.

FIG. 19 is a top view of a rigid element and wire according to the disclosure.

FIG. 20 is a perspective rear view of a rigid element and wire according to the disclosure.

FIG. 21 is a perspective side view of a rigid element and wire according to the disclosure.

FIG. 22 is a perspective top view of a rigid element and wire according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

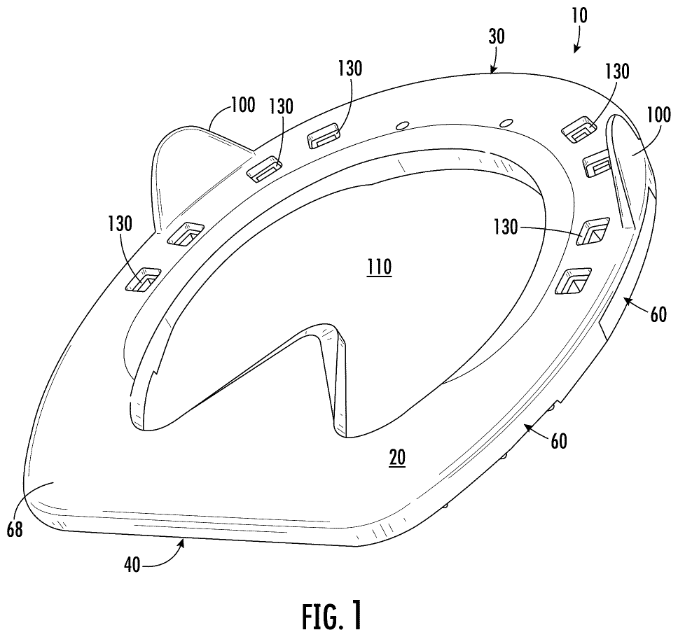

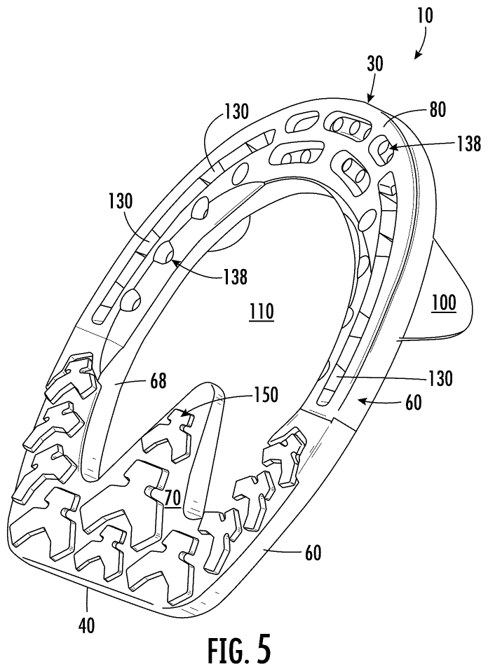

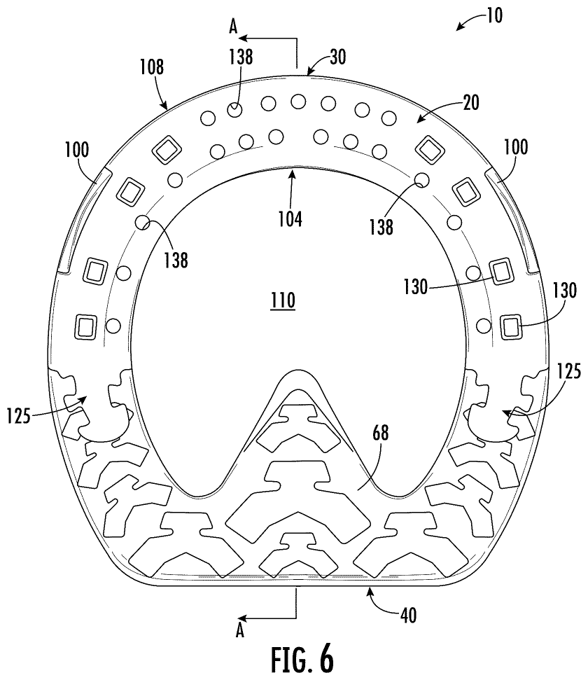

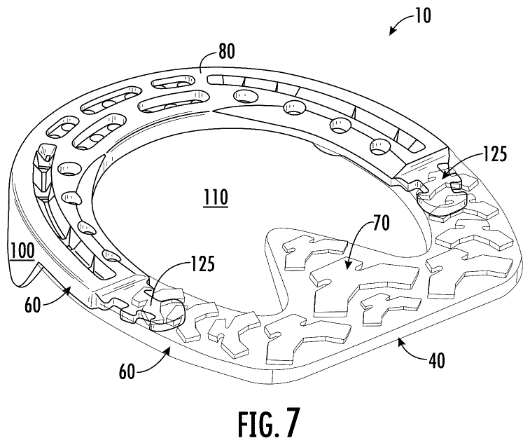

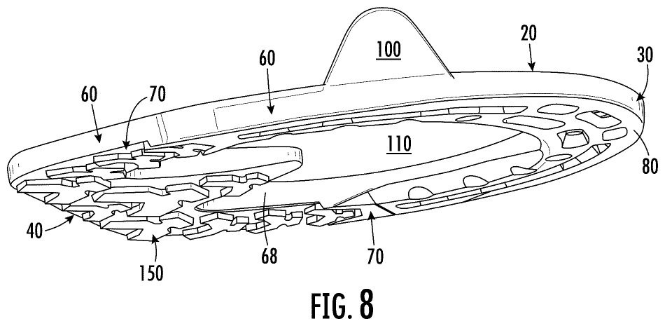

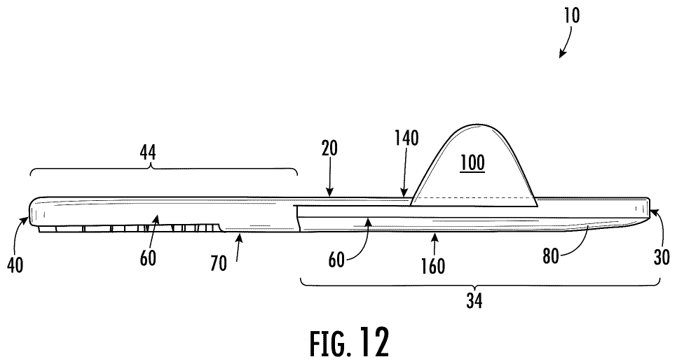

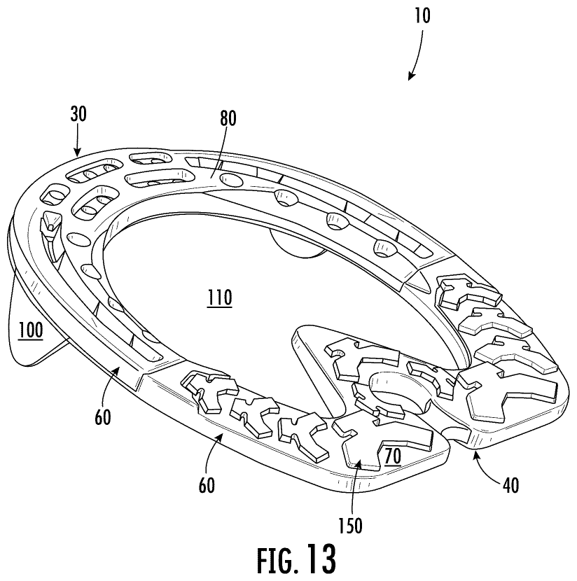

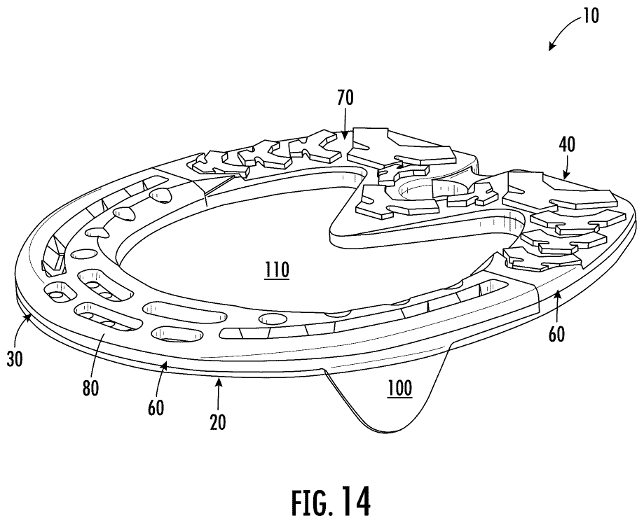

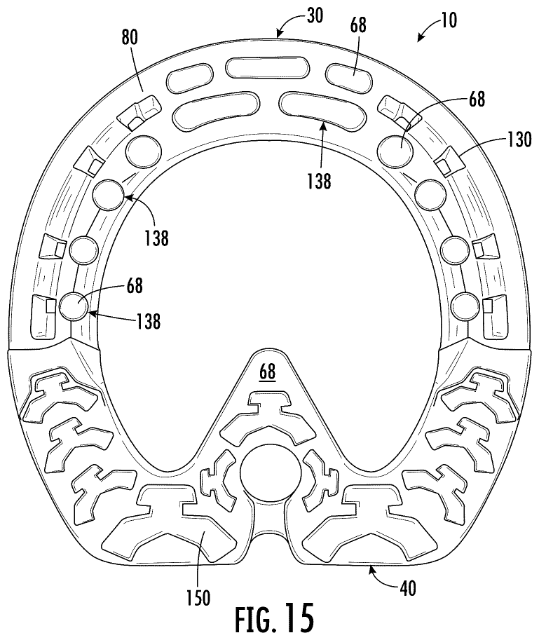

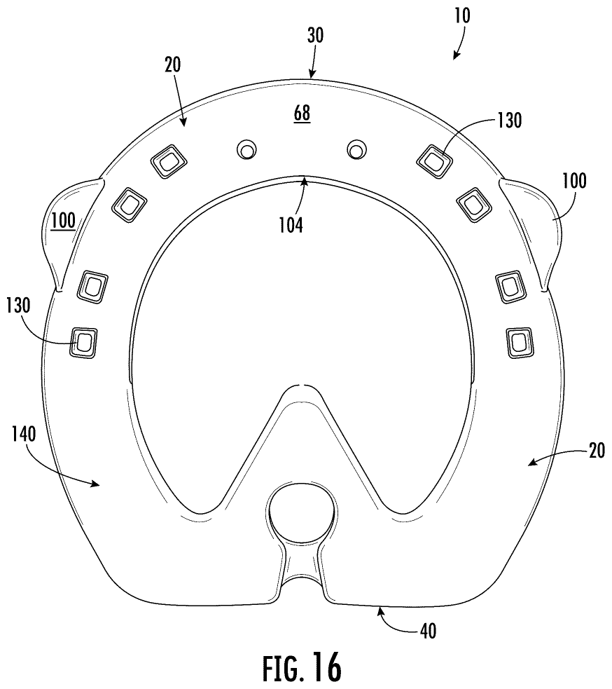

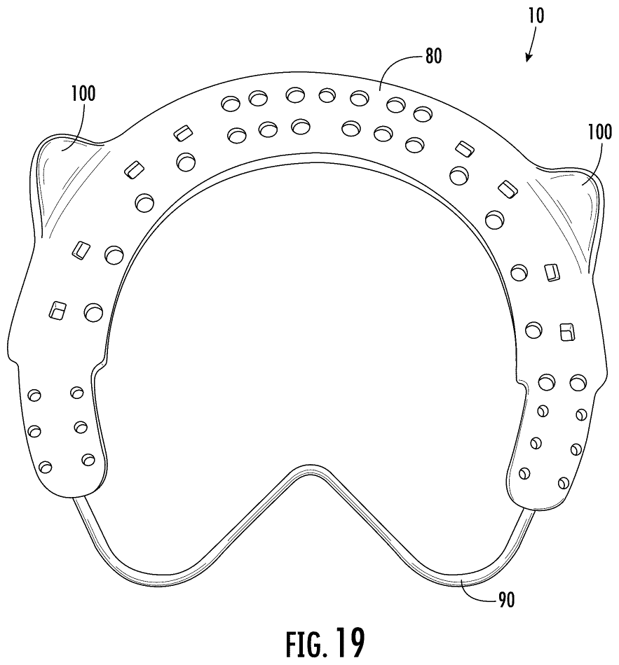

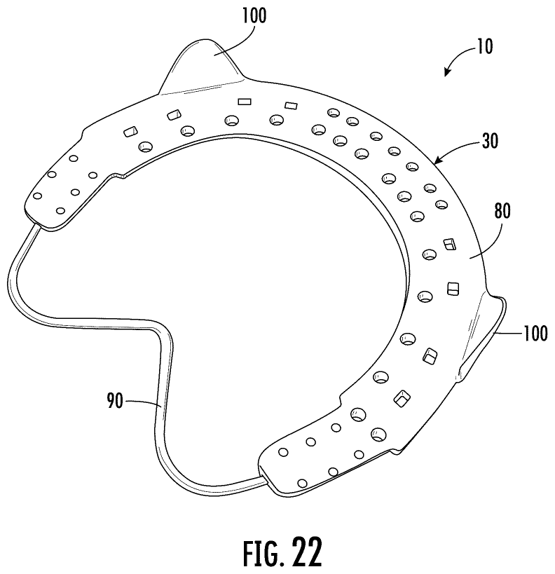

Embodiments of the present disclosure are best understood by referring to FIGS. 1-22 of the drawings, like numerals being used for like and corresponding parts of the various drawings.

### LIST OF REFERENCES

10 Shoe

20 Horse Sole Bed
30 Distal End
34 Coffin Region
40 Proximal End
44 Caudal Region
60 Lateral wall
68 Polymer element
70 Polymer Sole
80 Rigid Element
90 Wire
92 Punch
94 Weld
100 Distal Clip
104 Interior Arch
108 Exterior Arch
110 Cavity
125 Wing
130 Fenestration
138 Passages
140 Upper surface
150 Tread
160 Bottom

In general, as depicted in FIGS. 1-22, shoe 10 has a horse sole bed 20 with a distal end 30, proximal end 40, and lateral walls 60. Shoe 10 includes a polymer element 68 having a polymer sole 70 extending along a caudal region 44 (FIGS. 4, 9, and 12) and a horse sole bed 20 (FIGS. 1, 2, 10 and 12) that extends along the entire upper surface 140. Horse sole bed 20 provides for shock absorption along the entire region where it makes contact with the horse hoof. Further, shoe 10 includes a highly rigid element 80 disposed along the coffin region 34, which corresponds generally with a horse hoof coffin bone when the shoe is in use. Element 80 includes a wire 90 and a series of passages 138 and nail fenestrations 130. Fenestrations 130 allow a farrier to attach shoe 10 to a horse hoof by driving or inserting nails through shoe bottom 160, fenestrations 130, horse sole bed 20, and into the horse hoof. Preferably, element 68 is overmolded to element 80 such that element 68 is permanently and stably secured to element 80. Further, shoe 10 includes positioning and stability distal clips 100.

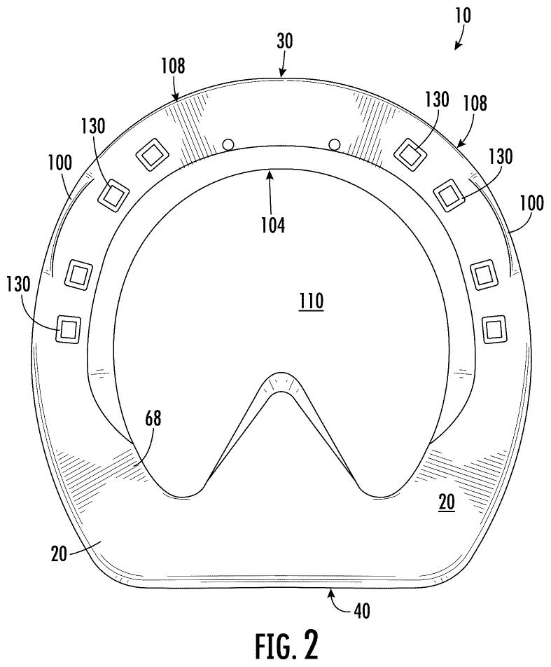

As depicted in FIGS. 1-15, shoe 10 has an element 68 disposed along caudal region 44. Element 68 thus corresponds with the back or caudal region of a horse's hoof. Element 68 provides protection and flexion to the caudal region of the horse's hoof, which naturally flexes when the horse moves or shifts its weight. Preferably, element 68 is formed of a polymer material that, in one preferred embodiment, is urethane. More specifically, the polymer material of one preferred embodiment is urethane having a durometer of between 80 A-90 A. The shoe's bottom 160 is provided with treads 150. Shoe 10 also has an upper surface 140 that forms a horse sole bed 20 configured to receive and support the sole of the horse hoof. The upper surface 140 and bottom 160 are connected by lateral wall 60. The shoe forms a central cavity 110. As shown in FIGS. 2, 6 and 9, the central portion of horse sole bed 20 (i.e., cavity 110) is generally formed in the shape of a segmented arc with an angular support, thus comfortably accommodating and supporting the frog of the horse hoof.

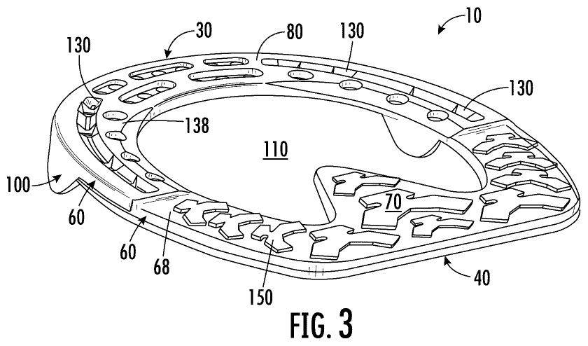

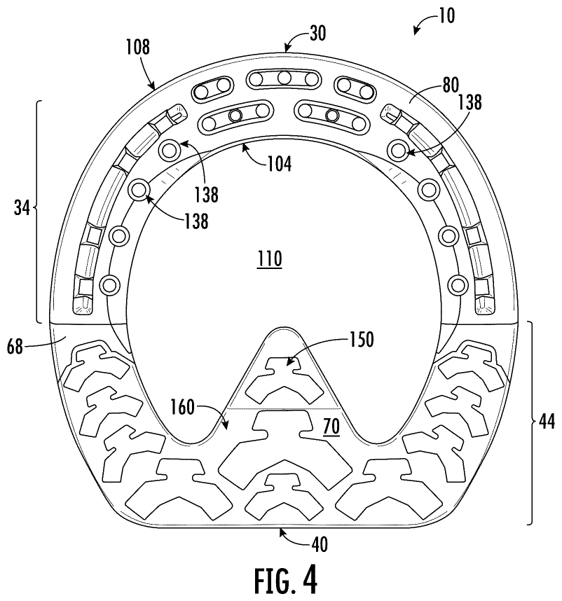

FIGS. 3-4 and 7-14 best illustrate highly rigid element 80. In one preferred embodiment, element 80 is formed of a metal such as steel or aluminum, although other highly rigid or stiff materials (for example, carbon fiber) will become apparent to a person of ordinary skill in the art in view of the present disclosure. Thus, element 80 provides a strong, highly rigid, durable support configured for the coffin bone region of the hoof. Although element 80 is highly rigid, it is preferably sufficiently malleable to permit a farrier to adjust the shoe to more precisely fit the shape of a hoof. As noted above, element 80 includes a number of fenestrations 130. Fenestrations are preferably rectangular to securely receive horseshoe nails, although any number of shapes can be used. Additionally, passageways 138 are provided through element 80 for the secure overmolding of element 68 to element 80.

Element 80 further includes integrally formed distal clips 100 near distal end 30 on the radially exterior portion of the shoe. The distal clips have an angle relative to the horse sole bed 20 that is less than the hoof angle such that, in use, the clips bend to match the hoof angle. This ensures that the clip abuts the hoof when in use. As a result, clips 100 help the farrier position the shoe on the foot. The distal clips also add stability by preventing distal sliding or movement of the horse foot in the shoe, and reduce stress on the horseshoe nails. Element 80 is also provided with angled or bent wings 125, which improve shape retention of the shoe as a horse steps on the back or proximal end 40 of the shoe. As shown in FIGS. 2, 4 and 6, element 80 has an interior arch 104 that generally matches the arch of central cavity 110. An exterior arch 108, by contrast is wider than arch 104.

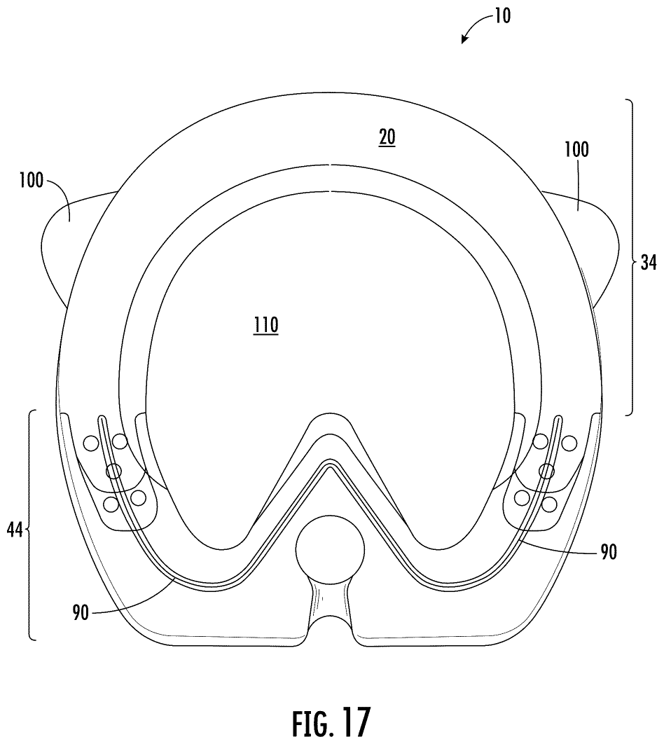

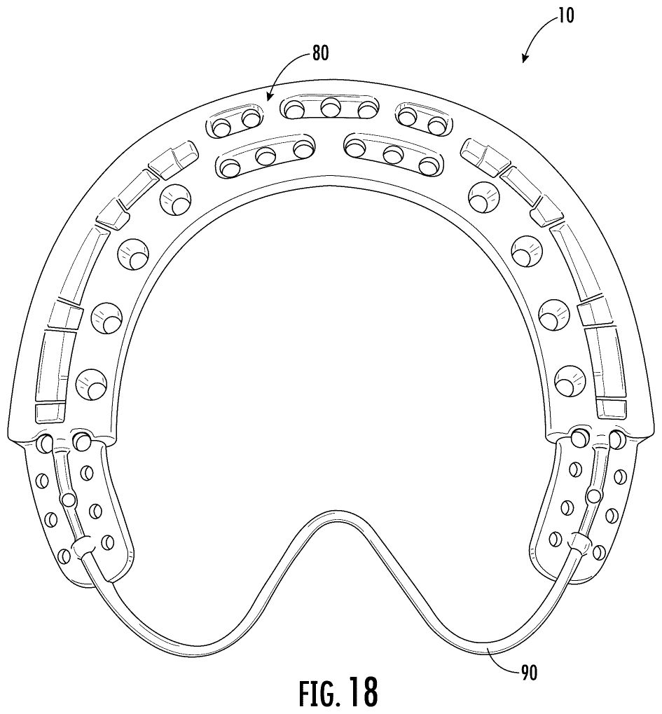

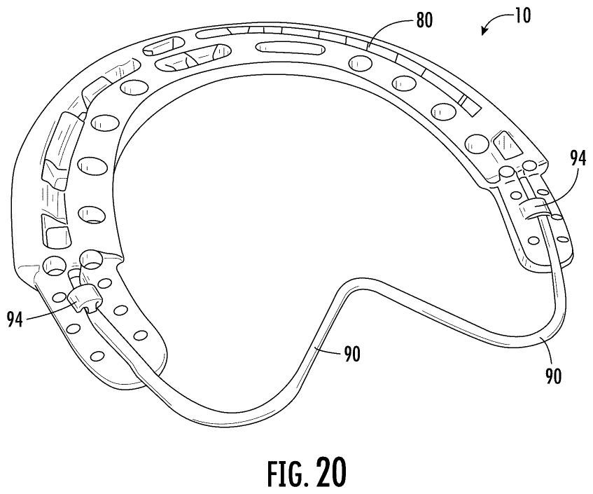

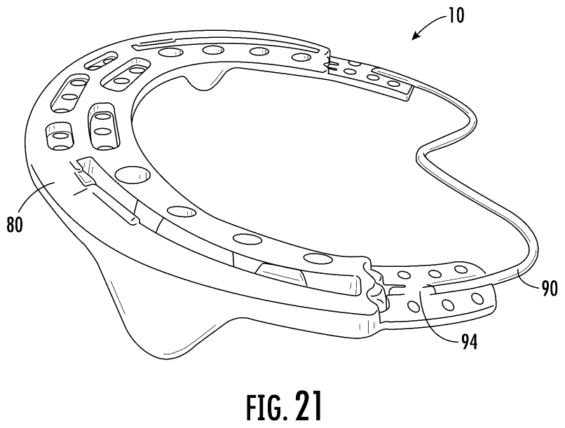

Referring to FIGS. 17-22, wire 90 is secured to rigid element by a punch 92 (e.g., FIG. 18), weld 94 (e.g., FIGS. 20-21), or other mechanical or bond approaches. As shown in FIG. 17, wire 90 extends in a curvilinear manner through the interior of the polymer element so as to provide structural integrity and avoid undesirable deformation of the frog segment of the polymer element during use. Wire 90 can be made of stainless steel, steel, extruded aluminum. While a wire is depicted, a number of suitable alternatives within the scope of this disclosure include bars, straps and tubes created by conventional extruding or rolling processes. Alternatively, multiple wires can be used. Wire 90 can be made from metal or metal alloys such as steel, stainless steel, aluminum or even rigid polymer having a high durometer.

The entire assembly of element 80 and wire 90 are overmolded with and bonded to polymer element 68. In one preferred embodiment, wire 90 maintains the generally flat form of polymer element 68, although a farrier can deform wire 90 to more securely and closely fit the anatomy of a particular hoof. In another preferred embodiment, wire 90 can be upwardly biased during manufacture.

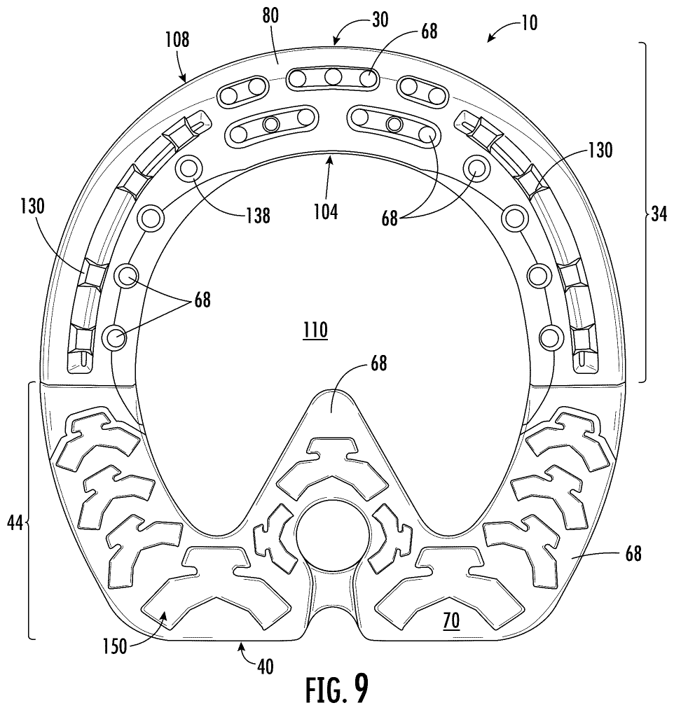

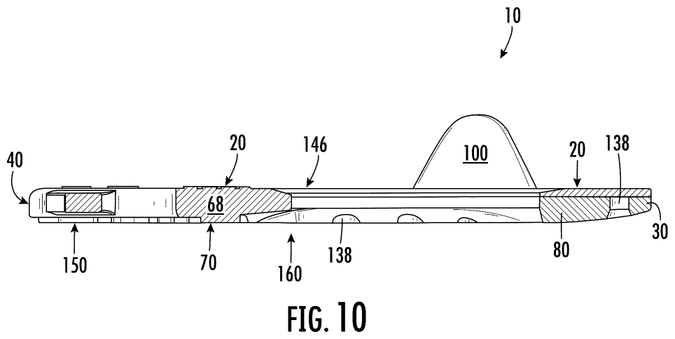

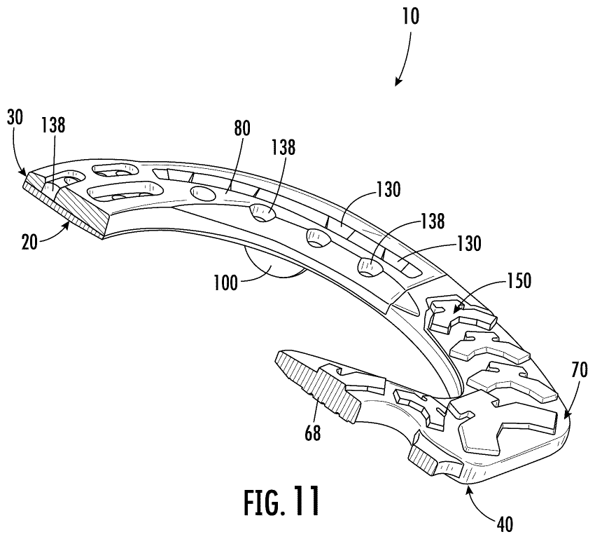

Referring to FIGS. 10-11, a cross section of shoe 10 is illustrated. As depicted in the cross section, a relatively thin section of polymer element extends over element 80 so as to provide a shock absorption material that further protects the horse hoof when in use. Further, as shown in FIGS. 9 and 15-16, the polymer element extends through passages 138, thereby securing element 68 to element 80 and improving on the durability and integrity of elements 68 and 80.

To fit the shoes 10, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods. Further, a farrier can adjust the proximal end of the shoe to precisely fit a horse by shaving element 68 as needed.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. A support device for an equine hoof, the support device comprising:
a rigid element having:
a rigid sole surface;
a rigid upper surface;
a rigid wall joining the sole surface and the upper surface;
a plurality of fenestrations extending between the sole surface and the upper surface;
a plurality of passages extending between the sole surface and the upper surface;
a polymer element having:
a polymer sole;
a polymer bed;
a polymer lateral wall joining the polymer sole and the polymer bed;
a plurality of fenestrations; and
wherein the polymer element is secured to the rigid element by overmolding.

2. The support device of claim 1, wherein a portion of the polymer element extends through the plurality of passages.

3. The support device of claim 2, wherein the polymer sole includes treads.

4. The support device of claim 2, wherein the rigid element is metal.

5. The support device of claim 4, wherein the metal is a steel alloy.

6. The support device of claim 4, wherein the metal is an aluminum alloy.

7. The support device of claim 2, wherein the rigid element is carbon fiber.

8. The support device of claim 1, wherein the polymer element is urethane.

9. The support device of claim 8, wherein the urethane has a durometer between 80 A and 90 A.

10. The support device of claim 2, further comprising a clip extending from the rigid upper surface.

11. The support device of claim 10, further comprising a second clip extending from the rigid upper surface.

12. The support device of claim 1, further comprising a wire extending through the polymer element, the wire being secured to the rigid element.

13. The support device of claim 12, wherein the wire is mechanically attached to the rigid element.

14. The support device of claim 12, wherein the wire is welded to the rigid element.

15. The support device of claim 12, wherein the wire forms a curvilinear configuration.

16. A support device for an equine hoof, the support device comprising:
a metal element having:
a rigid sole surface;
a rigid upper surface;
a rigid wall joining the sole surface and the upper surface;
a plurality of fenestrations extending between the sole surface and the upper surface;
a plurality of passages extending between the sole surface and the upper surface;
a urethane element having:
a polymer sole having treads;
a polymer bed;
a polymer lateral wall joining the polymer sole and the polymer bed;
a plurality of fenestrations;
a rigid wire extending through the polymer element, the wire being secured to the metal element; and
wherein the urethane element is secured to the metal element by overmolding through the plurality of passages.

17. The support device of claim 16, wherein the metal is a steel alloy.

18. The support device of claim 17, wherein the metal is an aluminum alloy.

19. The support device of claim 16, wherein the urethane element has a durometer between 80 A and 90 A.

20. The support device of claim 16, further comprising a clip extending from the rigid upper surface.
